(19) United States
(12) Patent Application Publication
(10) Pub. No.: US 2026/0339340 A1
(43) Pub. Date: Oct. 29, 2026

(54) CONTROL METHOD FOR UNDERWATER ROBOT, UNDERWATER ROBOT, AND STORAGE MEDIUM

(71) Applicant: SHENZHEN SEAUTO TECHNOLOGY CO., LTD., Shenzhen (CN)

(72) Inventor: Zhineng Deng, Shenzhen, Guangdong (CN)

(21) Appl. No.: 18/995,361

(22) PCT Filed: May 22, 2023
(86) PCT No.: PCT/CN2023/095577

§ 371 Date: Jan. 16, 2025

(30) Foreign Application Priority Data
Apr. 3, 2023 (CN) 202310346730.6

(51) Int. Cl. G05D 1/648; B63B 79/40; B63G 8/00; E04H 4/16; G05D 105/10; G05D 107/00

(52) U.S. Cl. CPC G05D 1/648; B63B 79/40; B63G 8/001; E04H 4/1654; G05D 2105/10; G05D 2107/29

(57) ABSTRACT

A control method for an underwater robot includes the following steps: in response to detecting that a time period when the underwater robot is out of water is greater than a first time duration, executing a machine protection action, and acquiring posture detection data, the posture detection data including an acceleration and/or an inclination angle; according to the posture detection data, determining a posture variation within a preset time period; and if the posture variation is less than a preset threshold, executing a return action. The posture data of the underwater robot after exiting the water is acquired, the posture variation within the preset time period is acquired according to the posture data, and when the posture variation is less than the preset threshold, the current means by which the current underwater robot exits the water is being on a step that is out of the water.

The present application claims priority to Chinese Patent Application No. 202310346730.6, filed with the China National Intellectual Property Administration on Apr. 3, 2023, and entitled “CONTROL METHOD FOR UNDERWATER ROBOT, UNDERWATER ROBOT, AND STORAGE MEDIUM”, which is incorporated herein by reference in its entirety.

### TECHNICAL FIELD

The present application relates to the technical field of robots, and in particular, to a control method for an underwater robot, an underwater robot, and a storage medium.

### BACKGROUND

An underwater robot may be used for a variety of underwater operations, such as repeatedly cleaning the bottom, walls and water lines of a swimming pool and filtering the water in the swimming pool. The underwater robots are helpful in clean daily garbage and dirt in the swimming pool, and completely changes the traditional cleaning manually and makes the swimming pool cleaning no longer troublesome.

In the related art, an underwater robot used for swimming pool cleaning is generally provided with a water entry detection function. The underwater robot executes a cleaning task only when the underwater robot in a water entry state is detected. The underwater robot can exit the water by active water exit or passive water exit. The active water exit is when the underwater robot climbs to a waterless step during cleaning, and passive water is when the underwater robot is lifted out of the water manually. The current underwater robot cannot differentiate a water exit mode of the underwater robot. The underwater robot stops cleaning after exiting water. After exiting the water, the underwater robot needs to be manually operated before returning to the swimming pool to continue cleaning such that the underwater robot stops the cleaning task caused by active water exit. The cleaning efficiency of the underwater robot may be low.

### SUMMARY

### Technical Field

The present application is to provide a control method for an underwater robot, an underwater robot, and a storage medium, wherein the cleaning efficiency may be increased by avoiding stoppage due to active water exit of the underwater robot.

### Technical Characteristics

The present application provides a control method for an underwater robot. The control method for the underwater robot includes the following steps:
in response to detecting that a time period when the underwater robot is out of water is greater than a first time duration, executing a machine protection action, and acquiring posture detection data, the posture detection data including an acceleration and/or an inclination angle;
determining a posture variation within a preset time period according to the posture detection data; and
if the posture variation is less than a preset threshold, executing a return action.

Optionally, the step of determining a posture variation within a preset time period according to the posture detection data includes:
determining an acceleration within the preset time period according to the posture detection data;
determining a maximum acceleration and a minimum acceleration within the preset time period according to the acceleration; and
determining the posture variation according to a difference between the maximum acceleration and the minimum acceleration.

Optionally, after the step of determining a posture variation within a preset time period according to the posture detection data, the method includes:
when the difference is greater than a preset acceleration and the inclination angle is greater than a preset inclination angle, determining that the posture variation is greater than or equal to a preset threshold; and
otherwise, determining that the posture variation is less than the preset threshold.

Optionally, after the step of determining a posture variation within a preset time period according to the posture detection data, the method further includes:
if the posture variation is greater than or equal to a preset threshold, controlling the underwater robot to stop a first target motor, and controlling the underwater robot to enter a standby state.

Optionally, the step of executing a machine protection action and acquiring posture detection data in response to detecting that a time period when the underwater robot is out of water is greater than a first time duration, the posture detection data including an acceleration and/or an inclination angle includes:
in response to detecting that the time period when the underwater robot is out of water is greater than the first time duration, controlling the underwater robot to stop a second target motor, and acquiring the inclination angle after waiting for a second time duration; or
controlling the underwater robot to stop the second target motor and then acquiring the acceleration.

Optionally, the step of executing a return action if the posture variation is less than a preset threshold includes:
if the posture variation is less than the preset threshold, controlling the underwater robot to start the second target motor, and executing a preset backward program.

Optionally, after the step of executing a return action if the posture variation is less than a preset threshold, the method further includes:
after a water entry instruction is received within a third time duration, controlling the underwater robot to execute a backward movement for a fourth time duration, and then executing a preset cleaning task; or
when the water entry instruction is not received within the third time duration, outputting abnormal prompt information.

Optionally, the step of outputting abnormal prompt information when the water entry instruction is not received within the third time duration includes:
when the water entry instruction is not received within the third time duration, controlling the underwater robot to stop a third target motor, then enter into a standby state, and outputting the abnormal prompt information.

In addition, to achieve the above objective, the present application further provides an underwater robot. The underwater robot includes a memory, a processor, and a control program configured for the underwater robot and stored in the memory, wherein when the processor executes the control program, the underwater robot is instructed to implements:
in response to detecting that a time period when the underwater robot is out of water is greater than a first time duration, executing a machine protection action, and acquiring posture detection data, the posture detection data including an acceleration and/or an inclination angle;
determining a posture variation within a preset time period according to the posture detection data; and
if the posture variation is less than a preset threshold, executing a return action.

In addition, to achieve the above objective, the present application further provides a computer-readable storage medium on which a control program for an underwater robot is stored, wherein when the processor executes the control program, the underwater robot is instructed to implements:
in response to detecting that a time period when the underwater robot is out of water is greater than a first time duration, executing a machine protection action, and acquiring posture detection data, the posture detection data including an acceleration and/or an inclination angle;
determining a posture variation within a preset time period according to the posture detection data; and
if the posture variation is less than a preset threshold, executing a return action.

### Beneficial Effects

Embodiments of the present application provide a control method for an underwater robot, an underwater robot, and a storage medium. The control method includes: in a process of executing a cleaning task by the underwater robot, in response to detecting that a time period when the underwater robot is out of water is greater than a first time duration, executing a machine protection action, and acquiring posture detection data, the posture detection data including an acceleration and/or an inclination angle; according to the posture detection data, determining a posture variation within a preset time period; and if the posture variation is less than a preset threshold, executing a return action. The water exit mode of the underwater robot is detected by the posture detection data of the underwater robot after exiting the water, and when a detected posture variation is less than a preset threshold (indicating that a means by which the underwater robot exits the water is being on a step that is out of the water, also called active water exit), the underwater robot can re-enter water and then execute a cleaning task by executing a return action, so that the cleaning task is prevented from being stopped due to active water exit, and the cleaning efficiency is improved.

### BRIEF DESCRIPTION OF DRAWINGS

The accompanying drawings herein are incorporated into the specification and constitute a part of the specification, show embodiments conforming to the present application, and are used together with the specification to explain a principle of the present application. To describe the technical solutions in the embodiments of the present application more clearly, the following briefly describes the accompanying drawings that need to be used in embodiments. Apparently, those of ordinary skill in the art may still derive other accompanying drawings from these accompanying drawings without creative efforts.

FIG. 1 is a schematic flowchart of a first embodiment of a control method for an underwater robot according to the present application;

FIG. 2 is a schematic diagram of acceleration-time variation of a control method for an underwater robot according to the present application;

FIG. 3 is a schematic flowchart of a second embodiment of a control method for an underwater robot according to the present application; and

FIG. 4 is a schematic diagram of a terminal hardware structure of embodiments of a control method for an underwater robot according to the present application.

The realization of the objectives, the functional features, and the advantages of the present application will be further explained in conjunction with the embodiments and with reference to the drawings.

### DETAILED DESCRIPTION

It should be understood that the specific embodiments described herein are merely illustrative of the present application and do not limit the present application.

In the related art, an underwater robot used for swimming pool cleaning is generally provided with a water entry detection function. The underwater robot executes a cleaning task only in response to detecting that the underwater robot is currently in a water entry state. The underwater robot exiting the water is divided into active water exit and passive water exit. The active water exit means that the underwater robot travels onto a step or a water surface in the cleaning process, and the passive water exit means that the underwater robot is dragged to a waterless area, for example, the underwater robot is manually lifted out of the water surface by the cleaning staff in the cleaning process. The underwater robot cannot judge the current water exit mode. The underwater robot stops cleaning after actively exiting water, and needs to be manually operated by the cleaning staff before returning to the swimming pool to continue cleaning. In this way, the underwater robot stops the cleaning task due to active water exit, resulting in low cleaning efficiency.

To solve the above defects, an embodiment of the present application provides a control method for an underwater robot, and a main solution thereof includes the following steps:
in response to detecting that a time period when the underwater robot is out of water is greater than a first time duration, executing a machine protection action, and acquiring posture detection data, the posture detection data including an acceleration and/or an inclination angle;
determining a posture variation within a preset time period according to the posture detection data; and
if the posture variation is less than a preset threshold, executing a return action.

According to the present application, the water exit mode of the underwater robot is detected by the posture detection data of the underwater robot after exiting the water, and when a detected posture variation is less than a preset threshold (indicating that a means by which the underwater robot exits the water is being on a step that is out of the water, also called active water exit), the underwater robot can re-enter water and then execute a cleaning task by executing a return action, so that the cleaning task is prevented from being stopped due to active water exit, and the cleaning efficiency is improved.

For a better understanding of the above technical solutions, the following describes exemplary embodiments of the present application in detail with reference to the accompanying drawings. Although exemplary embodiments of the present disclosure are shown in the accompanying drawings, it should be understood that the present disclosure can be implemented in various forms and should not be limited to the embodiments set forth herein. Rather, these embodiments are provided to enable a more thorough understanding of the present disclosure and to fully convey the scope of the present disclosure to those skilled in the art.

Referring to FIG. 1, FIG. 1 is a schematic flowchart of a first embodiment of a control method for an underwater robot according to the present application.

The solution of this embodiment is applied to an underwater robot, such as a swimming pool cleaning robot.

In this embodiment, the control method for the underwater robot includes the following steps:

Step S10: in response to detecting that a time period when the underwater robot is out of water is greater than a first time duration, executing a machine protection action, and acquiring posture detection data, the posture detection data including an acceleration and/or an inclination angle.

In this embodiment, the underwater robot is usually equipped with a water entry sensing device such as a water entry detection sensor, thereby enabling the underwater robot to have a water entry detection function. The water entry detection sensor is used to connect a cleaning circuit for a cleaning task. The water entry detection sensor may be used as a connection switch of a cleaning circuit. In response to detecting that the underwater robot is currently in the water, the cleaning circuit switch is connected, and the underwater robot can then execute a corresponding cleaning task. After the underwater robot exits the water, the connection switch of the cleaning circuit is in a disconnected state, and the underwater robot cannot continue to execute the cleaning operation. The underwater robot cannot judge the current water exit mode; consequently, the underwater robot stops executing the cleaning task after actively exiting the water, and further the cleaning efficiency is low.

Therefore, to improve the cleaning efficiency of the underwater robot, the water exit mode of the underwater robot needs to be judged, and when the current water exit mode is judged to be active water exit, the underwater robot can actively return to the water to continuously execute the cleaning task.

Specifically, in response to detecting that the time period when the underwater robot is out of water is greater than the first time duration, the underwater robot is controlled to stop a second target motor, and the inclination angle is acquired after waiting for a second time duration; or the underwater robot is controlled to stop the second target motor, and then the acceleration is acquired. The machine protection action is to stop the second target motor. The second target motor may be all motors or a motor associated with the cleaning task. The acceleration is historical acceleration data of the underwater robot.

For example, the first time duration is 1.5 seconds, the second target motor is a water pumping motor and a traveling motor associated with a cleaning task, and the second time duration is 3 seconds. In response to detecting that the time period when the underwater robot is out of water is greater than 1.5 seconds, the underwater robot is controlled to stop the water pumping motor and the traveling motor, and then the historical acceleration data of the underwater robot is acquired. After the underwater robot stops the water pumping motor and the traveling motor for three seconds, the current inclination angle is acquired in real time. Therefore, the underwater robot can judge the water exit mode based on the detected historical acceleration data and inclination angle.

It should be noted that the above parameters are only used for explanation and are not intended to limit the present application.

Step S20: determining a posture variation within a preset time period according to the posture detection data.

In this embodiment, if the posture detection data is an acceleration, the preset time period is a time period before the underwater robot exits water and after the underwater robot exits water. For example, a time period from 2 seconds before the underwater robot exits water to two seconds after the underwater robot exits water is the preset time period. When the posture detection data is an inclination angle, the preset time period is a time period after the underwater robot executes the machine protection action and waits for a second time duration. For example, the next 4 seconds after the underwater robot stops the target motor and waits for 3 seconds is a preset time period corresponding to the inclination angle, and the posture variation corresponding to the inclination angle is an inclination angle variation within 4 seconds.

It should be noted that the above parameters are only used for explanation and are not intended to limit the present application.

Specifically, the step of calculating the posture variation corresponding to the acceleration specifically includes:
step S21: determining an acceleration within the preset time period according to the posture detection data;
step S22: determining a maximum acceleration and a minimum acceleration within the preset time period according to the acceleration; and
step S23: determining the posture variation according to a difference between the maximum acceleration and the minimum acceleration.

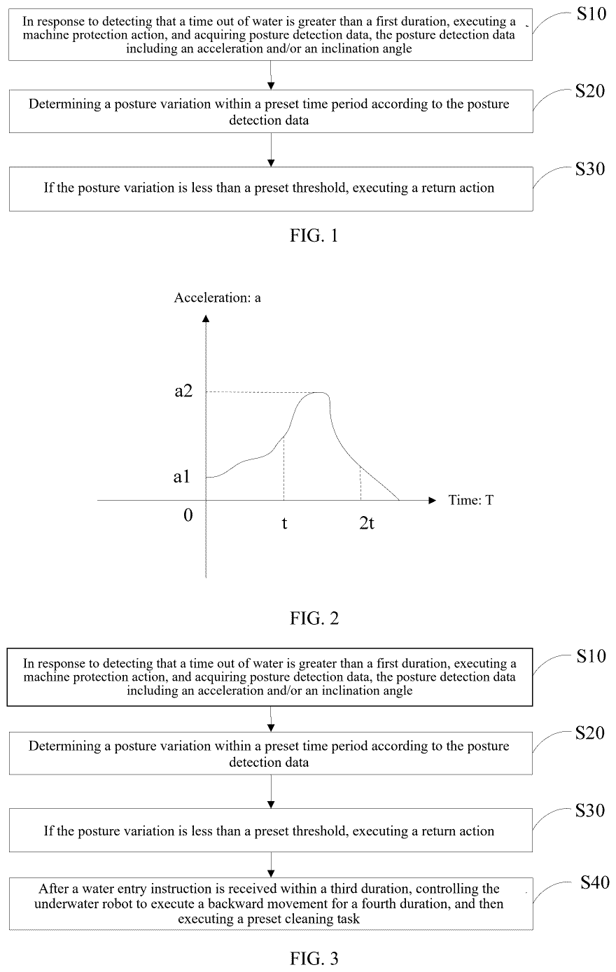

For example, referring to FIG. 2, FIG. 2 is a curve of an acceleration change of the underwater robot from being on the water surface to exiting the water surface, where t is the time of the underwater robot exiting the water. Therefore, the time period of 0-2t in FIG. 2 may be taken as the preset time period, and the acceleration within the preset time period determined from the posture detection data based thereon is the acceleration within the time period of 0-2t. Still referring to FIG. 2, in the time period of 0-2t, a maximum acceleration is a2, and a minimum acceleration is a1, so that the posture variation corresponding to the acceleration is a difference between a2 and a1.

Optionally, after an inclination angle variation is acquired and the difference between the maximum acceleration and the minimum acceleration is calculated, when the difference is greater than a preset acceleration and the inclination angle is greater than a preset inclination angle, the posture variation is judged to be greater than or equal to the preset threshold. Otherwise, the posture variation is judged to be less than the preset threshold.

Optionally, if the posture variation is greater than or equal to a preset threshold, the underwater robot is controlled to stop the first target motor, and the underwater robot is controlled to enter a standby state. Since the second target motor is stopped after the time of the underwater robot exiting the water exceeds a first time duration, and the second target motor is usually a motor associated with a cleaning task, the first target motor includes all motors that are not stopped. After the first target motor is stopped, the underwater robot is in a standby state or a just-started state. It may be understood that if the posture variation is greater than or equal to the preset threshold, the water exit mode of the underwater robot is passive water exit, that is, the underwater robot is lifted out of the water surface by the cleaning staff, so that the underwater robot may be controlled to stop the motor and enter a standby state, and a work indicator light changes from being on to flashing.

Step S30: if the posture variation is less than a preset threshold, executing a return action.

If the detected posture variation is less than the preset threshold, the current water exit mode of the underwater robot is active water exit, for example, climbing up steps and climbing out of the water on the pool wall. In this case, to prevent the underwater robot from stopping the cleaning operation, the underwater robot needs to be controlled to execute a return action, such as starting a backward program, so that the underwater robot returns to the water again and continues to execute the cleaning action.

Specifically, if the posture variation is less than the preset threshold, the underwater robot is controlled to start the second target motor, and a preset backward program is executed. In response to detecting that a time period when the underwater robot is out of water is greater than a first time duration, the underwater robot executes a machine protection action, that is, the second target motor is stopped. In this case, when the posture variation is less than a preset threshold, the second target motor needs to be restarted, so that the underwater robot can execute a cleaning action after entering water again.

Since the posture detection data includes an acceleration and/or an inclination angle, when the posture detection data is only the acceleration of the underwater robot, the posture variation is a difference between the maximum acceleration and the minimum acceleration of the underwater robot in a preset time period from before to after the underwater robot exits the water, and the preset threshold is a preset acceleration. Based on this, the step S30 specifically includes:
step S31: if the difference is less than the preset acceleration, determining that the water exit mode of the underwater robot is active water exit; and
step S32: in response to detecting that the water exit mode of the underwater robot is active water exit, controlling the underwater robot to execute a backward program.

When executing a cleaning task, the underwater robot is usually in a traveling state of uniform speed or slow acceleration, that is, the acceleration of the underwater robot tends to be stable. When the cleaning staff lifts the underwater robot out of the water, the acceleration changes greatly, and in response to detecting that the difference exceeds the preset acceleration, the water exit mode of the underwater robot is judged to be passive water exit. Since the water exit mode of the underwater robot is passive water exit, that is, the cleaning staff lifts the underwater robot out of the water, the underwater robot does not need to execute a backward program for returning to a swimming pool, and only the first target motor is stopped, so that the state of the underwater robot returns to a state when the underwater robot is just started, that is, the underwater robot enters a standby state.

Therefore, when the difference is less than the preset acceleration, the water exit mode of the underwater robot is the active water exit mode. In this case, the underwater robot can start the water pumping motor and execute a full-speed backward program, when detecting a water entry instruction again, the underwater robot can execute a backward action for a preset time period, and after the backward action is completed, the underwater robot can re-execute the cleaning task, thereby improving the cleaning efficiency of the underwater robot.

Optionally, when the posture detection data is only the inclination angle of the underwater robot, the posture variation is an inclination angle variation of the underwater robot within a preset time period in the future after the underwater robot stops the motor. For example, an inclination angle variation within 4 seconds in the future is acquired 3 seconds after the underwater robot stops the motor, and the preset threshold is a preset angle. Based on this, the step S30 further includes:
step S33: if the inclination angle variation is less than the preset angle, determining that the water exit mode of the underwater robot is active water exit; and
step S34: in response to detecting that the water exit mode of the underwater robot is active water exit, controlling the underwater robot to execute a backward program.

The underwater robot basically stops cleaning after exiting the water, so that the state of the underwater robot can be considered as a static state. In this case, the water exit mode of the underwater robot can be judged by acquiring an inclination angle variation of the underwater robot within a preset time period. The inclination angle may be acquired by a 3-axis gyroscope.

Based on this, if the inclination angle variation is less than the preset angle, the water exit mode of the underwater robot is the active water exit mode. In this case, the underwater robot can start the water pumping motor and execute a full-speed backward program, when detecting a water entry instruction again, the underwater robot can execute a backward action for a preset time period, and after the backward action is completed, the underwater robot can re-execute the cleaning task, thereby improving the cleaning efficiency of the underwater robot.

Optionally, when the posture detection data is the acceleration and the inclination angle of the underwater robot, the posture variation within a preset time period is a difference between a maximum acceleration and a minimum acceleration within the preset time period and an inclination angle variation. The preset threshold is a preset acceleration and a preset angle. Based on this, the step S30 further includes:
step S35: if the difference is less than the preset acceleration and the inclination angle variation is less than the preset angle, determining that the water exit mode of the underwater robot is active water exit; and
step S36: in response to detecting that the water exit mode of the underwater robot is active water exit, controlling the underwater robot to execute a backward program.

In this embodiment, the passive water exit means that the cleaning staff lifts the underwater robot out of the water. In a process that the underwater robot is lifted out of the water, the cleaning staff may lift the underwater robot out of the water at a constant speed by using a uniform force, so that the difference in this process is less than a preset acceleration, and this passive water exit method is mistaken by the underwater robot as active water exit.

Therefore, to improve the accuracy of determining the active water exit, in response to detecting that a time period when the underwater robot is out of water is greater than a first time duration and a machine protection action is executed, both the acceleration and the inclination angle of the underwater robot are acquired, and a maximum acceleration variation and an inclination angle variation within a preset time period are calculated. When the maximum acceleration variation is less than a preset acceleration and the inclination angle variation is less than a preset angle, the water exit mode of the underwater robot is judged to be active water exit, the underwater robot is controlled to execute a full-speed backward program, then a pumping mechanism is started, after the underwater robot re-enters water, the underwater robot executes the backward action for a preset time period and executes the cleaning task again after completing the backward action, so that the accuracy of determining the water exit mode is improved, and meanwhile, the cleaning efficiency of the underwater robot is improved.

According to the technical solution disclosed in the embodiment, in response to detecting that a time period when the underwater robot is out of water is greater than a first time duration, a robot protection action is executed, then the acceleration and/or the inclination angle of the underwater robot are acquired, and a difference between the maximum acceleration and the minimum acceleration within a preset time period and/or an inclination angle variation are determined according to the acceleration and/or the inclination angle. When the difference is less than the preset acceleration and/or the inclination angle variation is less than a preset angle, the water exit mode of the underwater robot is active water exit, and in this case, the underwater robot is controlled to execute a return action, so that the underwater robot returns to the water to execute the cleaning task again, the cleaning work is prevented from being stopped due to active water exit, and the cleaning efficiency of the underwater robot is improved.

Referring to FIG. 3, in a second embodiment, based on the first embodiment, after the step S30, the method further includes:

Step S40: after a water entry instruction is received within a third time duration, controlling the underwater robot to execute a backward movement for a fourth time duration, and then executing a preset cleaning task.

In this embodiment, the third time duration is a duration of the backward detection of the underwater robot. If the underwater robot does not enter water again within the third time duration, the previous water exit mode of the underwater robot based on the result of the comparison between the posture variation and the preset threshold is wrong, and the previous water exit made of the underwater robot is not active water exit. Therefore, when the underwater robot executes the backward program, if a water entry instruction sent by a water entry detection sensor is received within a third time duration, for example, within 20 seconds, the detection result of the previous water exit mode is considered as an accurate result. After the underwater robot enters water, the backward operation of a fourth time duration (for example, 10 seconds) is executed, so that the underwater robot rescans the cleaning area in the backward process, and further, when the cleaning task is executed again, the area which has been cleaned is prevented from being repeatedly cleaned, and the cleaning efficiency of the underwater robot after the underwater robot enters water again is improved.

Optionally, when the water entry instruction is not received within the third time duration, abnormal prompt information is output.

In a preset time period, for example, within 20 seconds, the underwater robot still does not receive the water entry instruction, the passive water exit of the underwater robot is detected as active water exit. In this case, the underwater robot can be controlled to stop the third target motor, then enter a standby state, and output an abnormal prompt information. The third target motor is all motors that are not stopped, the abnormal prompt information can include voice prompt information and character prompt information or a change in an indicator light from a steady on state to a flashing state, so as to prompt the cleaning staff to perform data analysis processing on the underwater robot. Data corresponding to the water exit detection result which is judged to be wrong is used as wrong reference data, and the accuracy of detecting the water exit of the underwater robot is improved based on the wrong reference data.

Optionally, if the underwater robot still does not receive the water entry instruction within the preset time period, the underwater robot is currently stuck in a certain area or a traveling motor of the underwater robot is abnormal. In this case, an error prompt can be output to prompt the cleaning staff to perform corresponding maintenance on the underwater robot.

According to the technical solution disclosed in the embodiment, whether the underwater robot receives the water entry instruction within the third time duration is detected, the cleaning staff can judge whether the previous water exit detection result of the underwater robot is accurate based on the instruction, and the accuracy of detecting the water exit of the underwater robot is improved based on the result.

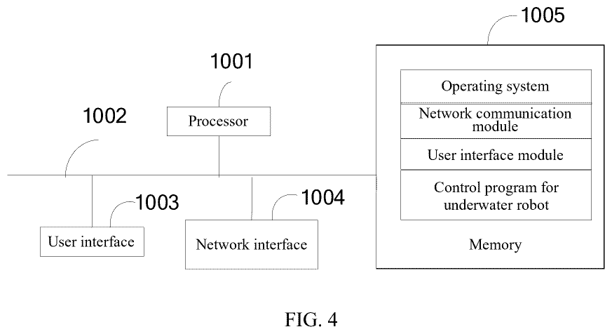

Referring to FIG. 4, FIG. 4 is a schematic diagram of a terminal structure of a hardware operating environment according to an embodiment of the present application.

As shown in FIG. 4, the terminal may include: a processor 1001 such as a CPU, a network interface 1004, a user interface 1003, a memory 1005, and a communication bus 1002. The communication bus 1002 is configured to implement connection and communication between these components. The user interface 1003 may include a display and an input unit such as a keyboard. Optionally, the user interface 1003 may also include a standard wired interface and a wireless interface. The network interface 1004 may optionally include a standard wired interface, and a wireless interface (e.g., a WI-FI interface). The memory 1005 may be a high-speed RAM memory or a non-volatile memory such as a disk memory. Optionally, the memory 1005 may be a storage device separate from the processor 1001.

Those skilled in the art may understand that the terminal structure shown in FIG. 4 does not constitute any limitation on the terminal. The terminal may include more or fewer components than those shown in the figure, or some components may be combined, or a different component deployment may be used.

As shown in FIG. 4, a memory 1005, as a computer storage medium, may include an operating system, a data storage module, a network communication module, and a control program for an underwater robot.

In the terminal shown in FIG. 4, the network interface 1004 is mainly used to connect a background server and perform data communication with the background server; and the processor 1001 may call a control program for an underwater robot stored in the memory 1005 and perform the following operations:
in response to detecting that a time period when the underwater robot is out of water is greater than a first time duration, executing a machine protection action, and acquiring posture detection data, the posture detection data including an acceleration and/or an inclination angle;
determining a posture variation within a preset time period according to the posture detection data; and
if the posture variation is less than a preset threshold, executing a return action.

Further, the processor 1001 may call a control program for an underwater robot stored in the memory 1005 and perform the following operations:
determining an acceleration within the preset time period according to the posture detection data;
determining a maximum acceleration and a minimum acceleration within the preset time period according to the acceleration; and
determining the posture variation according to a difference between the maximum acceleration and the minimum acceleration.

Further, the processor 1001 may call a control program for an underwater robot stored in the memory 1005 and perform the following operations:
when the difference is greater than a preset acceleration and the inclination angle is greater than a preset inclination angle, determining that the posture variation is greater than or equal to a preset threshold; and
otherwise, determining that the posture variation is less than the preset threshold.

Further, the processor 1001 may call a control program for an underwater robot stored in the memory 1005 and perform the following operations:
if the posture variation is greater than or equal to a preset threshold, controlling the underwater robot to stop a first target motor, and controlling the underwater robot to enter a standby state.

Further, the processor 1001 may call a control program for an underwater robot stored in the memory 1005 and perform the following operations:
in response to detecting that the time period when the underwater robot is out of water is greater than the first time duration, controlling the underwater robot to stop a second target motor, and acquiring the inclination angle after waiting for a second time duration; or
controlling the underwater robot to stop the second target motor and then acquiring the acceleration.

Further, the processor 1001 may call a control program for an underwater robot stored in the memory 1005 and perform the following operations:
if the posture variation is less than the preset threshold, controlling the underwater robot to start the second target motor, and executing a preset backward program.

Further, the processor 1001 may call a control program for an underwater robot stored in the memory 1005 and perform the following operations:
after a water entry instruction is received within a third time duration, controlling the underwater robot to execute a backward movement for a fourth time duration, and then executing a preset cleaning task; or
when the water entry instruction is not received within the third time duration, outputting abnormal prompt information.

Further, the processor 1001 may call a control program for an underwater robot stored in the memory 1005 and perform the following operations:
when the water entry instruction is not received within the third time duration, controlling the underwater robot to stop a third target motor, then enter into a standby state, and outputting the abnormal prompt information.

In addition, those of ordinary skill in the art can understand that all or part of the processes in the method of the above embodiment can be completed by instructing related hardware through a computer program. The computer program includes program instructions, and the computer program may be stored in a storage medium that is a computer-readable storage medium. The program instructions are executed by at least one processor in the control terminal to implement the process steps of the embodiment of the above method.

Therefore, the present application further provides a computer-readable storage medium on which a control program for an underwater robot is stored, wherein when the control program for the underwater robot is executed by a processor, the steps of the control method for the underwater robot described in the above embodiment are implemented.

It should be noted that, since the storage medium provided in the embodiment of the present application is the storage medium used to implement the method of the embodiment of the present application, based on the method introduced in the embodiment of the present application, those skilled in the art can understand the specific structure and deformation of the storage medium, and details are not described herein again. Any storage medium used in the method of the embodiment of the present application is within the protection scope of the present application.

It should be appreciated by those skilled in the art that embodiments of the present application may be provided as a method, a system, or a computer program product. Therefore, the present application may use a form of hardware only embodiments, software only embodiments, or embodiments with a combination of software and hardware. In addition, the present application may use a form of a computer program product that is implemented on one or more computer-usable storage media (including but not limited to a disk memory, a CD-ROM, and an optical memory) that include computer-usable program code.

The present application is described with reference to the flowcharts and/or block diagrams of the method, the device (system), and the computer program product according to the embodiments of the present application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may alternatively be stored in a computer-readable memory that can instruct a computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may alternatively be loaded onto the computer or another programmable data processing device, so that a series of operations and steps are performed on the computer or another programmable device, to generate computer-implemented processing. Therefore, the instructions executed on the computer or another programmable device provide steps for implementing a specific function in one or more processes in the flowcharts and/or in one or more blocks in the block diagrams.

It should be noted that, in the claims, any reference signs placed between parentheses shall not be constructed as limiting the claim. The word “comprise” does not exclude the presence of elements or steps not listed in the claim. The word “a” or “an” preceding an element does not exclude the presence of a plurality of such elements. The present application can be implemented by means of hardware including several distinct elements, and by means of a suitably programmed computer. In a unit claim enumerating several means, several of these means may be embodied by the same item of hardware. The usage of the words such as “first”, “second” and “third” do not indicate any order. These words may be interpreted as names.

Although some preferred embodiments of the present application have been described, those skilled in the art can make changes and modifications to these embodiments after learning the basic inventive concept. Therefore, the appended claims are intended to be construed as including the preferred embodiments and all changes and modifications that fall within the scope of the present application.

It is clear that those skilled in the art can make various modifications and variations to the present application without departing from the spirit and scope of the present application. In this way, the present application is intended to cover these modifications and variations of the present application provided that these modifications and variations fall within the scope of protection defined by the following claims and their equivalent technologies.

The above mentioned contents are merely preferred embodiments of the present application and are not intended to limit the patent scope of the present application. The equivalent structure or equivalent process transformation made by using the contents of the specification and the drawings of the present application, or direct or indirect applications to other related technical fields, are all included in the patent protection scope of the present application.

1. A control method for an underwater robot applied to an underwater robot, wherein the control method for the underwater robot comprises:
in response to detecting that a time period when the underwater robot is out of water is greater than a first time duration, executing a machine protection action, and acquiring posture detection data, the posture detection data comprising an acceleration and/or an inclination angle;
determining a posture variation within a preset time period according to the posture detection data; and
if the posture variation is less than a preset threshold, executing a return action.

2. The control method for the underwater robot according to claim 1, wherein determining the posture variation within the preset time period according to the posture detection data comprises:
determining an acceleration within the preset time period according to the posture detection data;
determining a maximum acceleration and a minimum acceleration within the preset time period according to the acceleration; and
determining the posture variation according to a difference between the maximum acceleration and the minimum acceleration.

3. The control method for the underwater robot according to claim 2, after determining the posture variation within the preset time period according to the posture detection data, the method further comprising:
when the difference is greater than a preset acceleration and the inclination angle is greater than a preset inclination angle, determining that the posture variation is greater than or equal to a preset threshold; and
otherwise, determining that the posture variation is less than the preset threshold.

4. The control method for the underwater robot according to claim 1, after determining the posture variation within the preset time period according to the posture detection data, the method further comprising:
if the posture variation is greater than or equal to a preset threshold, controlling the underwater robot to stop a first target motor, and controlling the underwater robot to enter a standby state.

5. The control method for the underwater robot according to claim 1, wherein executing the machine protection action and acquiring the posture detection data in response to detecting that a time period when the underwater robot is out of water is greater than a first time duration, the posture detection data comprising an acceleration and/or an inclination angle comprises:
in response to detecting that the time period when the underwater robot is out of water is greater than the first time duration, controlling the underwater robot to stop a second target motor, and acquiring the inclination angle after a second time duration; or
controlling the underwater robot to stop the second target motor and then acquiring the acceleration.

6. The control method for the underwater robot according to claim 5, wherein executing the return action if the posture variation is less than the preset threshold comprises:
if the posture variation is less than the preset threshold, controlling the underwater robot to start the second target motor, and executing a preset backward program.

7. The control method for the underwater robot according to claim 1, after executing the return action if the posture variation is less than the preset threshold, the method further comprising:
after a water entry instruction is received within a third time duration, controlling the underwater robot to execute a backward movement for a fourth time duration, and then executing a preset cleaning task; or
when the water entry instruction is not received within the third time duration, outputting abnormal prompt information.

8. The control method for the underwater robot according to claim 7, wherein outputting the abnormal prompt information when the water entry instruction is not received within the third time duration comprises:
when the water entry instruction is not received within the third time duration, controlling the underwater robot to stop a third target motor, then enter into a standby state, and outputting the abnormal prompt information.

9. An underwater robot comprising: a memory, a processor, and a control program configured for the underwater robot and stored in the memory, wherein when the processor executes the control program, the underwater robot is instructed to implements:
in response to detecting that a time period when the underwater robot is out of water is greater than a first time duration, executing a machine protection action, and acquiring posture detection data, the posture detection data comprising an acceleration and/or an inclination angle;
determining a posture variation within a preset time period according to the posture detection data; and
if the posture variation is less than a preset threshold, executing a return action.

10. A computer-readable storage medium on which a control program for an underwater robot is stored, wherein when the processor executed the control program, the underwater robot is instructed to implements:
in response to detecting that a time period when the underwater robot is out of water is greater than a first time duration, executing a machine protection action, and acquiring posture detection data, the posture detection data comprising an acceleration and/or an inclination angle;
determining a posture variation within a preset time period according to the posture detection data; and
if the posture variation is less than a preset threshold, executing a return action.
